(19) United States
(12) Patent Application Publication
(10) Pub. No.: US 2021/0302281 A1
(43) Pub. Date: Sep. 30, 2021

(54) Powder Sampling Thief

(71) Applicant: Pieter J. Groenewoud, Powder Springs, GA (US)

(72) Inventor: Pieter J. Groenewoud, Powder Springs, GA (US)

(21) Appl. No.: 17/212,639

(22) Filed: Mar. 25, 2021

Related U.S. Application Data
(60) Provisional application No. 63/000,015, filed on Mar. 26, 2020.

(51) Int. Cl. G01N 1/12; G01N 1/16

(52) U.S. Cl. CPC G01N 1/12; G01N 1/16

(57) ABSTRACT

A blended powder sampling thief for sampling a powder includes an elongated rod that has an upper portion and a lower portion. The lower portion defines at least one cavity. A tubular sheath is disposed about the rod and is slidable between a lower position in which the tubular sheath exposes the at least one cavity and an upper position in which the at least one cavity is exposed. When the rod is inserted into the powder and the tubular sheath is in the upper position, the powder flows into the at least one cavity. When the tubular sheath is slid into the lower position, a sample of the powder is entrapped in the at least one cavity so that when the sampling thief is removed from the powder, the sample of the powder will remain in the at least one cavity.

### CROSS-REFERENCE TO RELATED APPLICATION(S)

This application claims the benefit of U.S. Provisional Patent Application Ser. No. 63/000,015, filed Mar. 26, 2020, the entirety of which is hereby incorporated herein by reference.

### BACKGROUND OF THE INVENTION

### 1. Field of the Invention

The present invention relates to sampling systems and, more specifically, to a powder sampling system.

### 2. Description of the Related Art

Sampling of blended powders, such as blended pharmaceutical powders, is required by the FDA. Many companies have sampling problems, which cause bad assay values, bad uniformity values, etc. A typical sampling thief includes a sampling rod that defines an opening into which powder may flow and a tube around the rod that can be repositioned to close off the opening. The sampling thief is pushed into a powder being sampled, the tube is positioned to open the opening and then repositioned to close the opening to trap powder samples therein. The air released from the opening can cause fluidization separation of the components in the blended powder, which can result in a sample that does not correctly represent the actual mixture of the blended powder.

Some labs attempt to overcome such problems with statistical procedures, which can be suitable when the analytical results for the finished dosage form (tablets or capsules) are found to meet specifications. However, such procedures can be cumbersome and frequently leave room for doubt as to whether the blended powder was truly homogeneous.

Therefore, there is a need for sampling thief that samples blended powders so that the samples accurately represent the actual blend of the powders being sampled.

### SUMMARY OF THE INVENTION

The disadvantages of the prior art are overcome by the present invention which, in one aspect, is a blended powder sampling thief for sampling a powder. An elongated rod has an upper portion and a lower portion. The lower portion defines at least one cavity. A tubular sheath is disposed about the rod and is slidable between a lower position in which the tubular sheath exposes the at least one cavity and an upper position in which the at least one cavity is exposed. When the rod is inserted into the powder and the tubular sheath is in the upper position, the powder flows into the at least one cavity. When the tubular sheath is slid into the lower position, a sample of the powder is entrapped in the at least one cavity so that when the sampling thief is removed from the powder, the sample of the powder will remain in the at least one cavity.

In another aspect, the invention is a blended powder sampling system for sampling a powder. A sampling container holds the powder therein. An elongated rod has an upper portion, a lower portion and a pointed lower end. The lower portion defines at least one cavity. A tubular sheath is disposed about the rod and is slidable between a lower position in which the tubular sheath exposes the at least one cavity and an upper position in which the at least one cavity is exposed. When the rod is inserted into the sampling container and the tubular sheath is in the upper position, the powder flows into the at least one cavity. When the tubular sheath is slid into the lower position, a sample of the powder is entrapped in the at least one cavity so that when the sampling thief is removed from the powder, the sample of the powder will remain in the at least one cavity.

In yet another aspect, the invention is a blended powder sampler for sampling a powder that includes a sampling thief and a sampling container. The sampling thief that includes an elongated rod and a tubular sheath. The elongated rod has an upper portion and a lower portion. The lower portion defines a plurality of cavities. The tubular sheath is disposed about the rod and that is slidable between a lower position in which the tubular sheath exposes the plurality of cavities and an upper position in which the plurality of cavities is exposed. The sampling container includes a jar into which the powder is placed and a sampling funnel that is affixable to the jar. The sampling funnel defines a passage that is complimentary in shape to the tubular sheath so that that the power sampling thief is held closely as it is being slid into the powder. The passage is elongated so as to keep the sampling thief at a constant angle relative to the jar as it is inserted into the powder. When the rod is inserted into the sampling container and the tubular sheath is in the upper position, the powder flows into the plurality of cavities. When the tubular sheath is slid into the lower position, samples of the powder are entrapped in the plurality of cavities so that when the sampling thief is removed from the powder, the samples of the powder will remain in the plurality of cavities.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIG. 1A is a schematic diagram of one embodiment of a sampling thief in a first position.

FIG. 1B is a schematic diagram of the embodiment shown in FIG. 1A in a second position.

FIGS. 2A-2E is a series of schematic diagrams operation of the sampling thief.

FIG. 3 is a schematic diagram of a rod portion of the sampling thief.

FIG. 4A-4C are schematic diagrams of a sampling funnel and use thereof with a sampling thief and a sampling container.

FIGS. 5A-5C are schematic diagrams of an embodiment that includes a groove for escaping air.

FIGS. 6A-6C are photographs of a sampling thief.

FIGS. 7A-7B are photographs of a sampling segment of a sampling thief and sampling containers.

### DETAILED DESCRIPTION OF THE INVENTION

A preferred embodiment of the invention is now described in detail. Referring to the drawings, like numbers indicate like parts throughout the views. Unless otherwise specifically indicated in the disclosure that follows, the drawings are not necessarily drawn to scale. The present disclosure should in no way be limited to the exemplary implementations and techniques illustrated in the drawings and described below. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

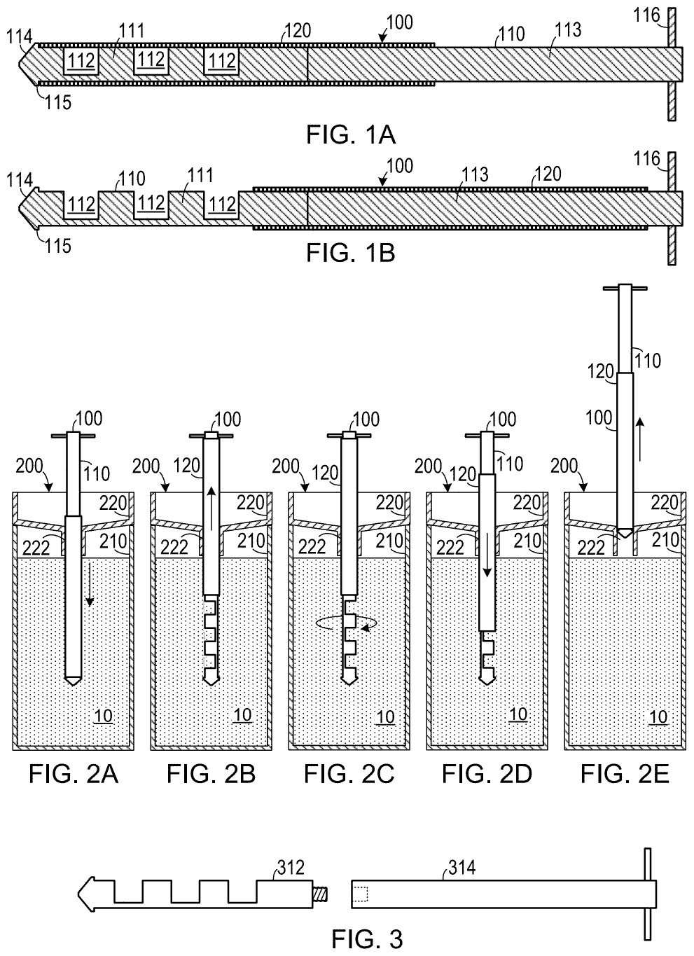

As shown in FIG. 1, one embodiment of a blended powder sampling thief 100 includes a rod 110 that defines one or more cavities 112 at the bottom end thereof. The rod 110 has a lower portion 111 and an upper portion 113. The bottom end of the rod 110 may include a pointed tip 114 to facilitate easy insertion into a powder being sampled. A handle 116 may be affixed to the top end of the rod 110. A tubular sheath 120 surrounds a portion of the rod 110 and is slidable from a lower position (as shown in FIG. 1A), which encloses the lower portion 111 and the cavities 112, to an upper position (as shown in FIG. 1B), which exposes the cavities 112. A lip 115 extending from the lower end of the rod 110 has a diameter that is greater than the inside diameter of the tubular sheath 120 so as to prevent it from sliding beyond the lower end of the rod 110. The rod 110 can be of one of many different diameters, depending upon the specific application.

In use, as shown in FIGS. 2A-2E, the sampling thief 100 can be used with a sampling container 200, which includes a sampling funnel 220 that is placed on a sample jar 210 to sample the blended powder 10. As shown in FIG. 2A, the sampling thief 100 is pushed into the powder 10. As shown in FIG. 2B, the tubular sheath 120 is retracted upwardly to expose the cavities 112 and thereby releasing the air from the cavities 112 into the powder 10. As shown in FIG. 2C, the rod 110 is twisted 180° so that powder that has not been exposed to the air from the cavities 112 fills the cavities 112. The tubular sheath 120 is then pushed downwardly to enclose the cavities 112—trapping the sampled powder therein, as shown in FIG. 2D, and then the sampling thief 100 with the sampled powder is withdrawn from the powder 10.

As shown in FIG. 3, the rod can include two portions: a thief portion 312 and a shaft portion 314. Different configurations of thief portion 312 may be screwed into the shaft portion 314 using a threaded coupling. For example, thief portions 312 with different size cavities may be used to satisfy different sampling requirements. Also, the thief portion 312 can have different numbers of cavities (e.g., from one to more than three) to satisfy specific sampling requirements. As shown, the cavities can be placed at different heights along the rod so as to facilitate sampling different vertical levels of the powder.

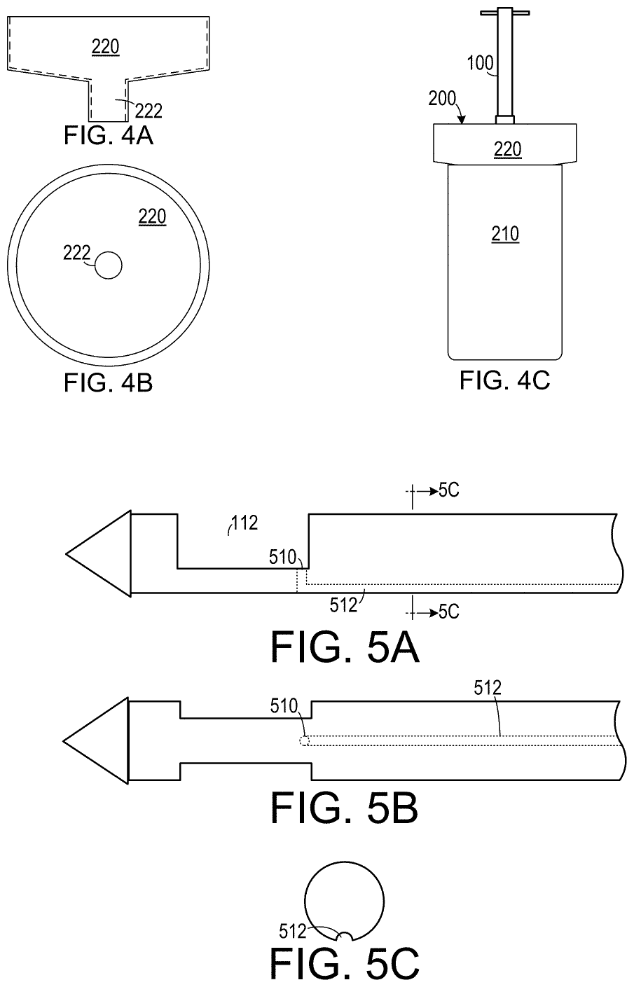

As shown in FIGS. 4A-4C, the sampling funnel 220 can be used to ensure sampling consistency. It engages a sample jar 210 and includes a passage 222 that is sized to facilitate insertion of the sampling thief 100.

An embodiment that includes an air escape groove is shown in FIGS. 5A-5C. For extremely difficult to sample powders, namely heterogeneous non-cohesive fine powder blends, the sample thief can include a sample-tip that allows for the escape of air from the cavity through the probe instead of through the powder blend. To achieve this, a small hole 110 can be drilled at the back top of the cavity to the backside of the sampling tip and a groove 512 would be milled up to the end of the tip. In this embodiment, when the powder falls into the cavity, most or all of the air will escape from this back channel up to the top of the probe. Also, in some embodiments, the diameter of the tip is greater than the diameter of the rod that leads to the handle, which facilitates escape of displaced air.

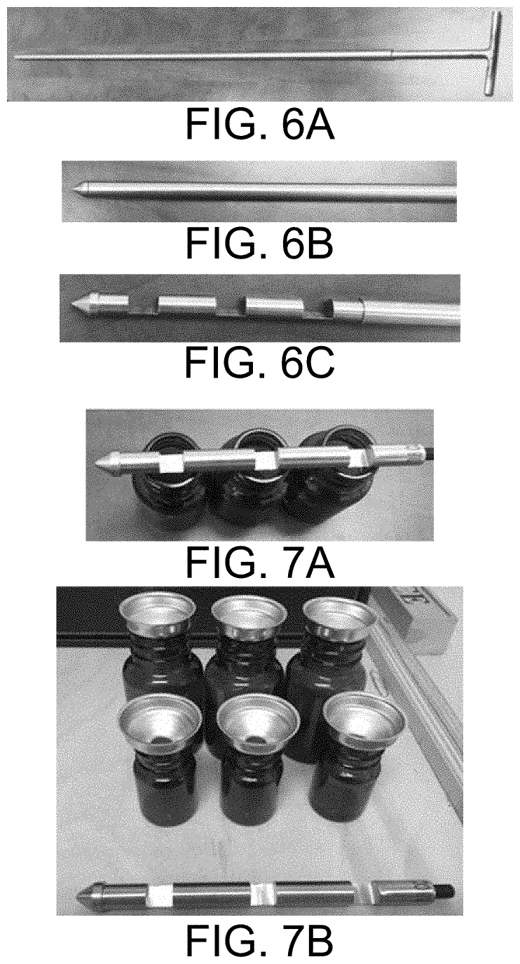

Photographs of one representative embodiment of a sampling thief are shown in FIGS. 6A-6C and photographs of one representative embodiment of a sampling thief, sample jars and sampling funnels are shown in FIGS. 7A-7B.

The sampling thief of the president invention allows the rod to be turned 180° when the sampling thief is in the open position in the blended powder. This facilitates “grabbing” a fresh sample that does not include air released from the cavities and that is likely to be more representative for the true distribution of the active drug in the blend.

The three-cavity design requires only a one time entering of the powder blend to sample at three different levels simultaneously. This presents an advantage because this system does not disturb the powder bed, which could influence the quality of the samples.

According to many pharmaceutical protocols, the sample weight of the powder taken by the cavity is usually in a range of from one to three times a weight of a desired finished dosage form and should not exceed three times the finished dosage weight. (For example, if the tablet weight will be 250 mg, each of the blend samples should have a weight in a range between 250 mg to 750 mg.) To achieve this, the cavity should have dimensions such that the volume of the cavity divided by the density of the powder equals a sample weight within the desired range. The following formula can be used to determine the dimensions of the cavity:

$$v = L π {R}^{2} - L \frac{{R}^{2}}{2} ( ( \frac{π}{180 °} ) ( ( C - sin C ) ) )$$

where:
L=length of cavity;
v=volume of cavity;
R=radius of rod;
C=central angle between each endpoint of the remaining segment of the rod after machining of the cavity.

Although specific advantages have been enumerated above, various embodiments may include some, none, or all of the enumerated advantages. Other technical advantages may become readily apparent to one of ordinary skill in the art after review of the following figures and description. It is understood that, although exemplary embodiments are illustrated in the figures and described below, the principles of the present disclosure may be implemented using any number of techniques, whether currently known or not. Modifications, additions, or omissions may be made to the systems, apparatuses, and methods described herein without departing from the scope of the invention. The components of the systems and apparatuses may be integrated or separated. The operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set. It is intended that the claims and claim elements recited below do not invoke 35 U.S.C. § 112(f) unless the words “means for” or “step for” are explicitly used in the particular claim. The above-described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. A blended powder sampling thief for sampling a powder, comprising:
(a) an elongated rod having an upper portion and a lower portion, the lower portion defining at least one cavity; and
(b) a tubular sheath disposed about the rod and that is slidable between a lower position in which the tubular sheath exposes the at least one cavity and an upper position in which the at least one cavity is exposed,
wherein after the rod is inserted into the powder and the tubular sheath is in the upper position, the powder flows into the at least one cavity and when the tubular sheath is slid into the lower position, a sample of the powder is entrapped in the at least one cavity so that when the sampling thief is removed from the powder, the sample of the powder will remain in the at least one cavity.

2. The blended powder sampling thief of claim 1, wherein the rod has a shape that allows rotation of the rod with the tubular sheath.

3. The blended powder sampling thief of claim 1, wherein the rod has a lower end that has a lip extending therefrom, wherein the lip has a diameter that is greater than an inside diameter of the tubular sheath so that the tubular sheath is prevented from sliding beyond the lip.

4. The blended powder sampling thief of claim 1, further comprising a handle affixed to an upper end of the rod.

5. The blended powder sampling thief of claim 1, wherein the lower end of the rod defines a plurality of cavities, each of which is at a different height along the rod so as to sample the power at a corresponding plurality of different levels.

6. The blended powder sampling thief of claim 1, wherein the rid defines a vent running along the rod and in fluid communication with the cavity, wherein the vent allows air that is displaced by power flowing into the at least one cavity to escape therefrom.

7. The blended powder sampling thief of claim 6, wherein the vent comprises:
(a) a groove defined by the rod on a side opposite from the at least one cavity; and
(b) a hole that extends from a top area of the at least one cavity into the groove.

8. The blended powder sampling thief of claim 1, wherein the upper portion of the rod is separable from the lower portion of the rod.

9. A sampling container for use with the powder sampling thief of claim 1, comprising:
(a) a jar into which the powder is placed; and
(b) a sampling funnel that is affixable to the jar and that defines a passage that is complimentary in shape to the tubular sheath so that that the power sampling thief is held closely as it is being slid into the powder.

10. The sampling container of claim 9, wherein the passage is elongated so as to keep the sampling thief at a constant angle relative to the jar as it is inserted into the powder.

11. A blended powder sampling system for sampling a powder, comprising:
(a) a sampling container that holds the powder therein;
(b) an elongated rod having an upper portion and a lower portion, the lower portion defining at least one cavity; and
(c) a tubular sheath disposed about the rod and that is slidable between a lower position in which the tubular sheath exposes the at least one cavity and an upper position in which the at least one cavity is exposed,
wherein when the rod is inserted into the sampling container and the tubular sheath is in the upper position, the powder flows into the at least one cavity and when the tubular sheath is slid into the lower position, a sample of the powder is entrapped in the at least one cavity so that when the sampling thief is removed from the powder, the sample of the powder will remain in the at least one cavity.

12. The blended powder sampling system of claim 11, wherein the cavity has a volume that is a function of a density of the powder so that a sample weight in the cavity is in a range of from one to three times a weight of a desired finished dosage form, wherein the cavity has dimensions that are determined according to the following formula:
$$v = L π {R}^{2} - L \frac{{R}^{2}}{2} ( ( \frac{π}{180 °} ) ( ( C - sin C ) ) )$$
where:
L=length of cavity;
v=volume of cavity;
R=radius of rod; and
C=central angle between each endpoint of the remaining segment of the rod after machining of the cavity.

13. The blended powder sampling system of claim 11, wherein the rod has a lower end that has a lip extending therefrom, wherein the lip has a diameter that is greater than an inside diameter of the tubular sheath so that the tubular sheath is prevented from sliding beyond the lip.

14. The blended powder sampling system of claim 11, further comprising a handle affixed to an upper end of the rod.

15. The blended powder sampling system of claim 11, wherein the lower end of the rod defines a plurality of cavities, each of which is at a different height along the rod so as to sample the power at a corresponding plurality of different levels.

16. The blended powder sampling system of claim 11, wherein the rid defines a vent running along the rod and in fluid communication with the cavity, wherein the vent allows air that is displaced by power flowing into the at least one cavity to escape therefrom.

17. The blended powder sampling system of claim 16, wherein the vent comprises:
(a) a groove defined by the rod on a side opposite from the at least one cavity; and
(b) a hole that extends from a top area of the at least one cavity into the groove.

18. The blended powder sampling system of claim 11, wherein the upper portion of the rod is separable from the lower portion of the rod.

19. The blended powder sampling system of claim 11, wherein the sampling container comprises:
(a) a jar into which the powder is placed; and
(b) a sampling funnel that is affixable to the jar and that defines a passage that is complimentary in shape to the tubular sheath so that that the power sampling thief is held closely as it is being slid into the powder, wherein the passage is elongated so as to keep the sampling thief at a constant angle relative to the jar as it is inserted into the powder.

20. A blended powder sampler for sampling a powder, comprising:
(a) a sampling thief that includes:
(i) an elongated rod having an upper portion and a lower portion, the lower portion defining a plurality of cavities, the rod having pointed lower end; and
(ii) a tubular sheath disposed about the rod and that is slidable between a lower position in which the tubular sheath exposes the plurality of cavities and an upper position in which the plurality of cavities is exposed; and
(b) a sampling container, including:
(i) a jar into which the powder is placed; and
(ii) a sampling funnel that is affixable to the jar and that defines a passage that is complimentary in shape to the tubular sheath so that that the power sampling thief is held closely as it is being slid into the powder, wherein the passage is elongated so as to keep the sampling thief at a constant angle relative to the jar as it is inserted into the powder,
wherein when the rod is inserted into the sampling container and the tubular sheath is in the upper position, the powder flows into the plurality of cavities and when the tubular sheath is slid into the lower position, samples of the powder are entrapped in the plurality of cavities so that when the sampling thief is removed from the powder, the samples of the powder will remain in the plurality of cavities.
